(19) United States
(12) Patent Application Publication
(10) Pub. No.: US 2020/0324476 A1
(43) Pub. Date: Oct. 15, 2020

(54) THREE-DIMENSIONAL SHAPING APPARATUS

(71) Applicant: KANTATSU CO., LTD., Yaita-shi (JP)

(72) Inventors: Eiji OSHIMA, Yaita-shi (JP); Hisanori SUZUKI, Sukagawa-city (JP)

(21) Appl. No.: 16/665,203

(22) Filed: Oct. 28, 2019

(30) Foreign Application Priority Data
Oct. 26, 2018 (JP) 2018-201381

(51) Int. Cl. B29C 64/268; B29C 64/135; B33Y 30/00; B23K 26/352; B23K 26/342; B23K 26/06; B23K 26/082

(52) U.S. Cl. CPC B29C 64/268; B29C 64/135; B33Y 30/00; B23K 26/352; B23K 2103/42; B23K 26/0665; B23K 26/0648; B23K 26/082; B23K 26/342

(57) ABSTRACT

Uniform shaping is performed. A three-dimensional shaping apparatus includes a laser source, an optical scanner that reflects a laser beam emitted from the laser source to be scanned toward a shaping table, and a condenser lens that is arranged between the optical scanner and the shaping table, and condenses the laser beam reflected by the optical scanner.

This application is based upon and claims the benefit of priority from Japanese patent application No. 2018-201381, filed on Oct. 26, 2018, the disclosure of which is incorporated herein in its entirety by reference.

### BACKGROUND OF THE INVENTION

### Field of the Invention

The present invention relates to a three-dimensional shaping apparatus.

### Description of the Related Art

In the above technical field, patent literature 1 discloses an apparatus in which no condenser lens is arranged behind an optical scanner.

[Patent Literature 1] Japanese Patent Laid-Open No. 2017-94563

### SUMMARY OF THE INVENTION

In the technique described in the above literature, however, since no condenser lens is arranged behind an optical scanner, it is impossible to perform uniform shaping.

The present invention provides a technique of solving the above-described problem.

One example aspect of the present invention provides a three-dimensional shaping apparatus comprising:

a laser source;

an optical scanner that reflects a laser beam emitted from the laser source to be scanned toward a shaping table; and

a condenser lens that is arranged between the optical scanner and the shaping table, and condenses the laser beam reflected by the optical scanner.

According to the present invention, since a condenser lens is arranged behind an optical scanner, it is possible to perform uniform shaping.

### BRIEF DESCRIPTION OF THE DRAWINGS

FIG. 1 is a view showing the arrangement of a three-dimensional shaping apparatus according to the first example embodiment of the present invention;

FIG. 2 is a view showing the arrangement of a three-dimensional shaping apparatus according to the second example embodiment of the present invention;

FIG. 3 is a table showing the characteristics of a condenser lens of a three-dimensional shaping apparatus according to the third example embodiment of the present invention;

FIG. 4 is a graph for explaining the relationship between an incident angle and a reflectance in the condenser lens of the three-dimensional shaping apparatus according to the third example embodiment of the present invention;

FIG. 5 is a view for explaining a normal angle in the condenser lens of the three-dimensional shaping apparatus according to the third example embodiment of the present invention;

FIG. 6A is a view showing an outline of the arrangement of the three-dimensional shaping apparatus according to the third example embodiment of the present invention;

FIG. 6B is a view showing the performance of the condenser lens of the three-dimensional shaping apparatus according to the third example embodiment of the present invention;

FIG. 7A is a view showing an outline of the arrangement of a three-dimensional shaping apparatus according to the fourth example embodiment of the present invention;

FIG. 7B is a view showing the performance of a condenser lens of the three-dimensional shaping apparatus according to the fourth example embodiment of the present invention;

FIG. 8A is a view showing an outline of the arrangement of a three-dimensional shaping apparatus according to the fifth example embodiment of the present invention;

FIG. 8B is a view showing the performance of a condenser lens of the three-dimensional shaping apparatus according to the fifth example embodiment of the present invention;

FIG. 9A is a view showing an outline of the arrangement of a three-dimensional shaping apparatus according to the sixth example embodiment of the present invention;

FIG. 9B is a view showing the performance of a condenser lens of the three-dimensional shaping apparatus according to the sixth example embodiment of the present invention;

FIG. 10A is a view showing an outline of the arrangement of a three-dimensional shaping apparatus according to the seventh example embodiment of the present invention;

FIG. 10B is a view showing the performance of a condenser lens of the three-dimensional shaping apparatus according to the seventh example embodiment of the present invention;

FIG. 11A is a view showing an outline of the arrangement of a three-dimensional shaping apparatus according to the eighth example embodiment of the present invention;

FIG. 11B is a view showing the performance of a condenser lens of the three-dimensional shaping apparatus according to the eighth example embodiment of the present invention;

FIG. 12A is a view showing an outline of the arrangement of a three-dimensional shaping apparatus according to the ninth example embodiment of the present invention;

FIG. 12B is a view showing the performance of a condenser lens of the three-dimensional shaping apparatus according to the ninth example embodiment of the present invention;

FIG. 13A is a view showing an outline of the arrangement of a three-dimensional shaping apparatus according to the 10th example embodiment of the present invention;

FIG. 13B is a view showing the performance of a condenser lens of the three-dimensional shaping apparatus according to the 10th example embodiment of the present invention;

FIG. 14A is a view showing an outline of the arrangement of a three-dimensional shaping apparatus according to the 11th example embodiment of the present invention;

FIG. 14B is a view showing the performance of a condenser lens of the three-dimensional shaping apparatus according to the 11th example embodiment of the present invention;

FIG. 15A is a view showing an outline of the arrangement of a three-dimensional shaping apparatus according to the 12th example embodiment of the present invention;

FIG. 15B is a view showing the performance of a condenser lens of the three-dimensional shaping apparatus according to the 12th example embodiment of the present invention;

FIG. 16A is a view showing an outline of the arrangement of a three-dimensional shaping apparatus according to the 13th example embodiment of the present invention;

FIG. 16B is a view showing the performance of a condenser lens of the three-dimensional shaping apparatus according to the 13th example embodiment of the present invention;

FIG. 17 is a view for explaining the arrangement of a three-dimensional shaping apparatus according to the 14th example embodiment of the present invention;

FIG. 18 is a perspective view showing an example of a three-dimensional shaped object including microchannels shaped using the three-dimensional shaping apparatus according to the 14th example embodiment of the present invention;

FIG. 19 is a perspective view showing another example of the three-dimensional shaped object including microchannels shaped using the three-dimensional shaping apparatus according to the 14th example embodiment of the present invention; and

FIG. 20 is a perspective view showing still other example of the three-dimensional shaped object including microchannels shaped using the three-dimensional shaping apparatus according to the 14th example embodiment of the present invention.

### DESCRIPTION OF THE EXAMPLE EMBODIMENTS

Example embodiments of the present invention will now be described in detail with reference to the drawings. It should be noted that the relative arrangement of the components, the numerical expressions and numerical values set forth in these example embodiments do not limit the scope of the present invention unless it is specifically stated otherwise.

### First Example Embodiment

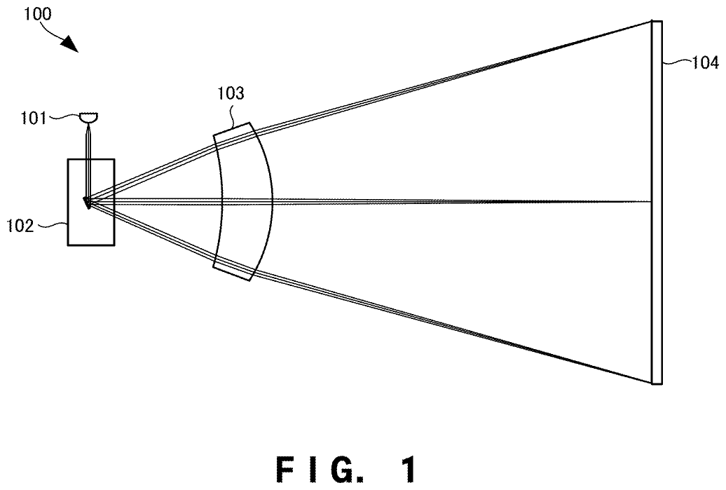

A three-dimensional shaping apparatus 100 according to the first example embodiment of the present invention will be described with reference to FIG. 1.

The three-dimensional shaping apparatus 100 is an apparatus that shapes a three-dimensional shaped object.

As shown in FIG. 1, the three-dimensional shaping apparatus 100 includes a laser source 101, an optical scanner 102, and a condenser lens 103.

The laser source 101 is a source of a laser beam. The optical scanner 102 reflects the laser beam emitted from the laser source 101 to be scanned toward a shaping table 104. The condenser lens 103 is arranged between the optical scanner 102 and the shaping table 104 to condense the laser beam reflected by the optical scanner 102.

According to this example embodiment, since the condenser lens is provided between the optical scanner and the shaping table, it is possible to perform uniform shaping.

### Second Example Embodiment

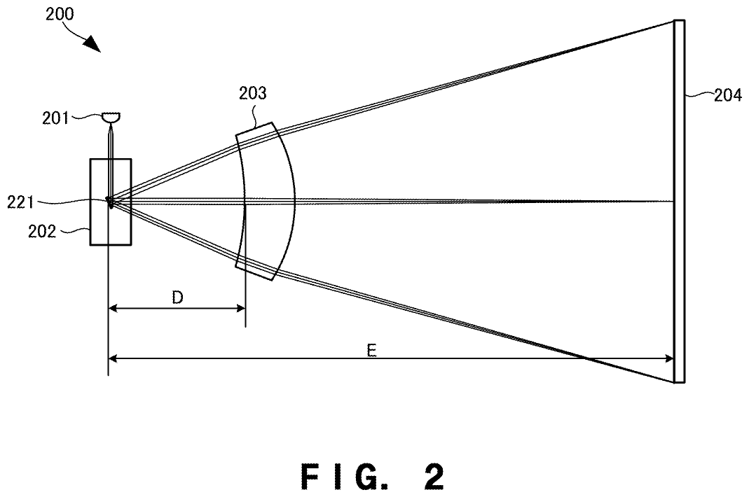

A three-dimensional shaping apparatus according to the second example embodiment of the present invention will be described next with reference to FIG. 2. FIG. 2 is a view for explaining the arrangement of the three-dimensional shaping apparatus according to this example embodiment. A three-dimensional shaping apparatus 200 includes a laser source 201, an optical scanner 202, a condenser lens 203, and a shaping table 204.

The laser source 201 emits a laser beam (light ray). The laser source 201 is an LD (Laser Diode), and is a laser beam oscillation element that oscillates a laser beam such as an ultraviolet laser beam, a visible laser beam, or an infrared laser beam.

The optical scanner 202 reflects the laser beam emitted from the laser source 201 to be scanned toward the shaping table. More specifically, the optical scanner 202 includes a two-dimensional MEMS (Micro Electro Mechanical System) mirror 221. Since the two-dimensional MEMS mirror 221 can be moved in the two-dimensional directions, the laser beam reflected by the two-dimensional MEMS mirror 221 is scanned in the two-dimensional directions toward the shaping table in accordance with the movement of the two-dimensional MEMS mirror 221. The two-dimensional MEMS mirror 221 is an electromechanical mirror. Note that two one-dimensional MEMS mirrors may be used, instead of the two-dimensional MEMS mirror 221.

The condenser lens 203 condenses the laser beam reflected by the optical scanner 202. The condenser lens 203 is arranged at a position where E/D<5.0 is satisfied. In this example, D represents a distance from the two-dimensional MEMS mirror 221 of the optical scanner 202 to one of two surfaces of the condenser lens 203, which is closer to the optical scanner 202. Furthermore, E represents a distance from the two-dimensional MEMS mirror 221 of the optical scanner 202 to the shaping table 204. Note that if E/D is larger than 5.0, a lens effective diameter becomes small. However, an NA (Numerical Aperture) value is small, and it is thus difficult to condense the laser beam.

The condenser lens 203 is arranged at a position where 3.5<E/D is satisfied. Note that if E/D is smaller than 3.5, the NA value becomes large and thus the beam diameter of the laser beam becomes small. Since, however, the lens effective diameter becomes large, structural arrangement is difficult.

According to this example embodiment, since the condenser lens is arranged between the optical scanner and the shaping table, it is possible to reduce the beam diameter of the laser beam, and thus perform uniform shaping.

### Third Example Embodiment

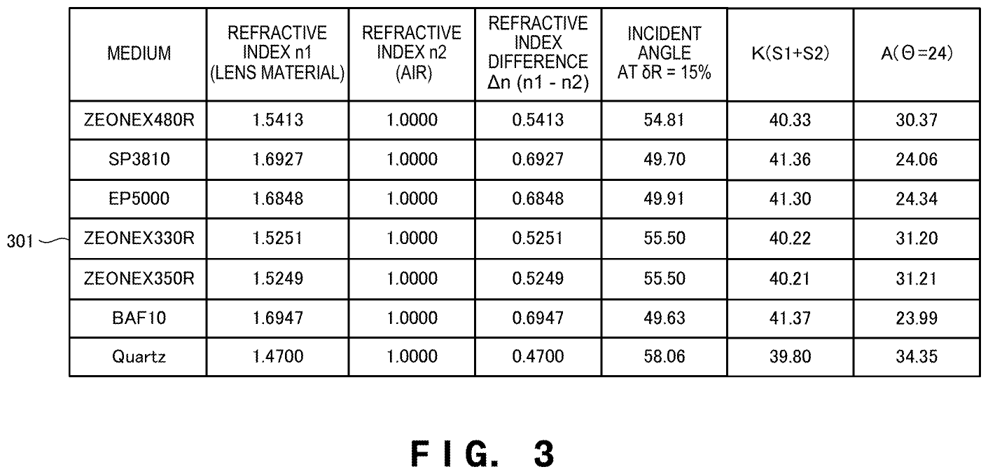

A three-dimensional shaping apparatus according to the third example embodiment of the present invention will be described next with reference to FIGS. 3 to 6B. FIG. 3 is a table showing the characteristics of a condenser lens of the three-dimensional shaping apparatus according to this example embodiment.

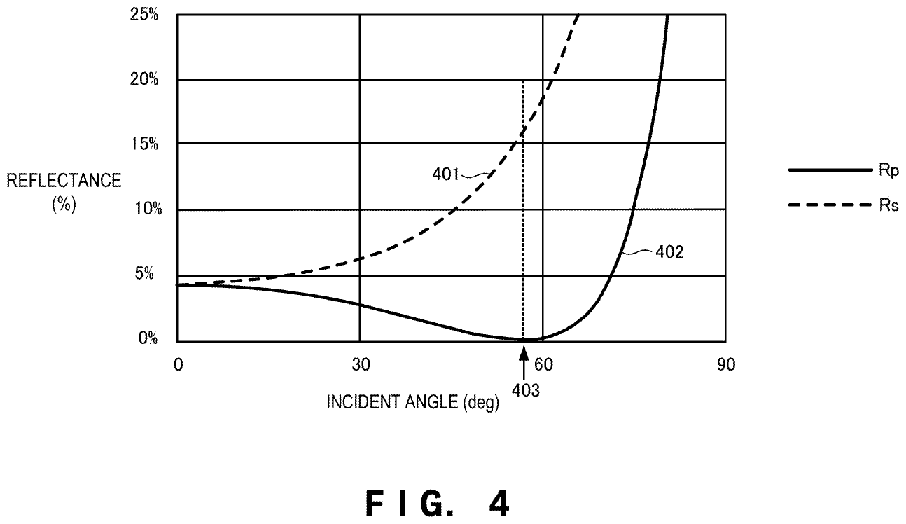

FIG. 4 is a graph for explaining the relationship between an incident angle and a reflectance in the condenser lens of the three-dimensional shaping apparatus according to this example embodiment. The three-dimensional shaping apparatus according to this example embodiment is different from that in the above-described second example embodiment in that the condenser lens has a predetermined shape. The remaining components and operations are the same as those in the second example embodiment. Hence, the same reference numerals denote the same components and operations, and a detailed description thereof will be omitted.

Since a laser beam emitted from an LD (Laser Diode) is linearly polarized light, a laser beam reflected by a mirror is also linearly polarized light. Thus, a laser beam entering the condenser lens is also linearly polarized light. In accordance with the Fresnel equations shown below, a reflectance Rₚ of vertically polarized light (p-polarized light) and a reflectance Rₛ of horizontally polarized light (s-polarized light) are given by:

Rₚ=tan²(α−β)/tan²(α+β)

Rₛ=sin²(α−β)/sin²(α+β)

where α represents an incident angle and β represents a refractive index. The reflectance depends on the incident angle, and is different between the p-polarized light and the s-polarized light.

Let I₀ be the intensity of the laser beam reflected by the mirror. Then, an intensity I of a laser beam that reaches a shaping table (image plane) is given by:

I=I₀−Ir (Jr: reflection intensity)

As the reflectance is higher, the intensity of the laser beam on the shaping table decreases.

As shown in FIG. 3, if a lens material is ZEONEX330R (301), the refractive index is 1.5251 when the wavelength of the laser beam is 405 nm, and thus the reflectances are as shown in the graph of FIG. 4. As shown in FIG. 4, while the angle is equal to or smaller than a Brewster angle (403), the reflectance (Rₛ) (401) of the s-polarized light simply increases, and the reflectance (Rₚ) (402) of the p-polarized light simply decreases.

However, even if the incident angle is the same, the reflectance changes depending on the incident angle on the lens since the laser beam is linearly polarized light. In addition, the intensity of the laser beam on the shaping stage is different. Therefore, a shaped object is nonuniform. In this example embodiment, a uniform shaped object is shaped by making the reflectance difference between the p-polarized light and the s-polarized light equal to or less than 15%, preferably 10%, and more preferable 5%. As for ZEONEX330R, in accordance with the Fresnel equations, the incident angle is 35.4° or less and the reflectance difference between the p-polarized light and the s-polarized light is 5%.

Note that FIG. 3 shows values obtained by calculating, in accordance with the Fresnel equations, the refractive index of each lens material at a wavelength of 405 nm and the incident angle when the reflectance difference between the p-polarized light and the s-polarized light is 15%. Note that An represents there refractive index difference between each lens material and air.

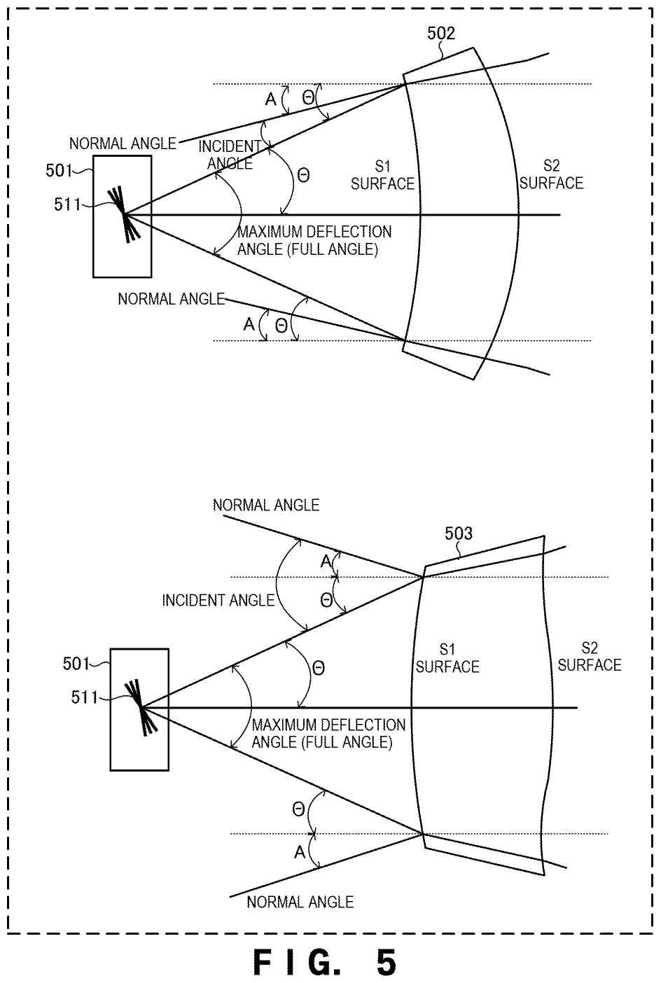

FIG. 5 is a view for explaining a normal angle in the condenser lens of the three-dimensional shaping apparatus according to this example embodiment. The relationship between the normal angle (A) and the laser beam deflection angle (Θ: maximum view angle (half angle)) of a laser beam reflected by an optical scanner 501 to enter a condenser lens 502 (condenser lens 503) is as shown in FIG. 5. The optical scanner 501 includes a two-dimensional MEMS mirror 511. Note that the two-dimensional MEMS mirror 511 reflects the laser beam to be scanned in the two-dimensional directions while swinging the mirror surface in the two-dimensional directions.

The reflectances of the p-polarized light and the s-polarized light depend on a laser beam incident angle and a refractive index difference. In this case, the relationship between the laser beam incident angle and the refractive index difference for each lens material shown in FIG. 3 when δR=15% (the reflectance difference is 15% or less) is given by equation (1) below.

K=(laser beam incident angle)×sqrt(Δn) (1)

for K satisfies

0<K<40 (2)

Referring to FIG. 3, K of ZEONEX330R (301) is 40.22. However, since the reflectance difference on an S2 surface (a surface far from the optical scanner 501) out of the two surfaces of the condenser lens 502 is smaller than that on an S1 surface (a surface close to the optical scanner 501) out of the two surfaces of the condenser lens 502, K need only satisfy expression (2). The same applies to other lens materials.

Since “laser beam incident angle=laser beam deflection angle (Θ)+normal angle (A)”, “K=(A+Θ)×sqrt(Δn)” is obtained as equation (1), and a substitution of equation (1) into expression (2) yields

0<(A+Θ)×sqrt(Δn)<40

Development of the above expression yields

0<A+Θ<40/sqrt(Δn)

Further arrangement of the above expression yields

−Θ<A<40/sqrt(Δn)−Θ (3)

The condenser lens 502 is a lens having a shape satisfying expression (3) above.

By using the lens having such shape, the condenser lens 502 has the sum of the difference between the reflectance of the vertically polarized light (p-polarized light) and that of the horizontally polarized light (s-polarized light) on the surface (S1 surface) close to the optical scanner 501 out of the two surfaces and the difference between the reflectance of the vertically polarized light (p-polarized light) and that of the horizontally polarized light (s-polarized light) on the surface (S2 surface) far from the optical scanner 501 out of the two surfaces, which is equal to or less than 15%, preferably 10%, and more preferable 5%.

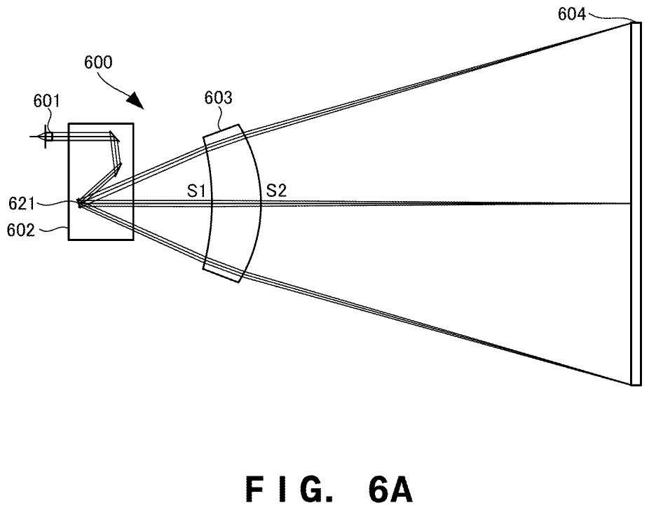

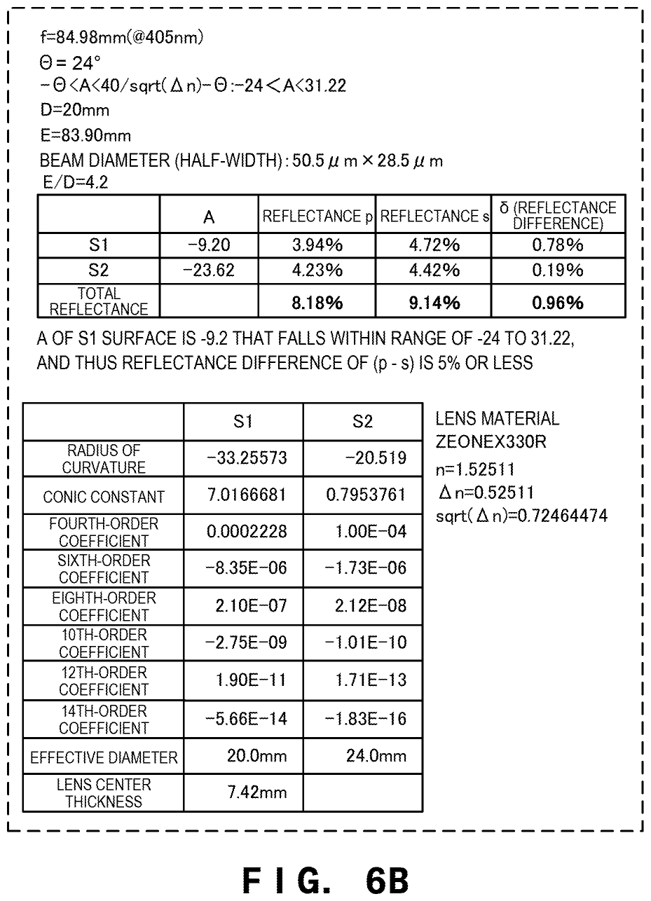

FIG. 6A is a view showing an outline of the arrangement of the three-dimensional shaping apparatus according to this example embodiment. FIG. 6B is a view showing the performance of the condenser lens of the three-dimensional shaping apparatus according to this example embodiment. A three-dimensional shaping apparatus 600 includes a laser source 601, an optical scanner 602, a condenser lens 603, and a shaping table 604. The laser source 601 emits a laser beam of 405 nm. The optical scanner 602 includes a two-dimensional MEMS mirror 621, and the two-dimensional MEMS mirror 621 reflects the laser beam to be scanned toward the shaping table 604. The lens material of the condenser lens 603 is ZEONEX330R, and the condenser lens 603 has a focal length (f) of 84.98 mm (405 nm laser beam) and a laser beam deflection angle (Θ) of 24°, satisfies −24<A<31.22, and has other characteristics shown in FIG. 6B.

The sum of the difference between the reflectance of the vertically polarized light and that of the horizontally polarized light on the S1 surface and the difference between the reflectance of the vertically polarized light and that of the horizontally polarized light on the S2 surface is 0.96% which is less than 5%. A distance D from the two-dimensional MEMS mirror 621 to the S1 surface is 20 mm, a distance E from the two-dimensional MEMS mirror 621 to the shaping table 604 is 83.90 mm, and E/D is 4.2. The beam diameter of the laser beam condensed by the condenser lens 603 and reduced is 50.5 μm×28.5 μm.

According to this example embodiment, it is possible to reduce the beam diameter of the laser beam, and thus perform uniform shaping. In addition, precise processing is possible.

### Fourth Example Embodiment

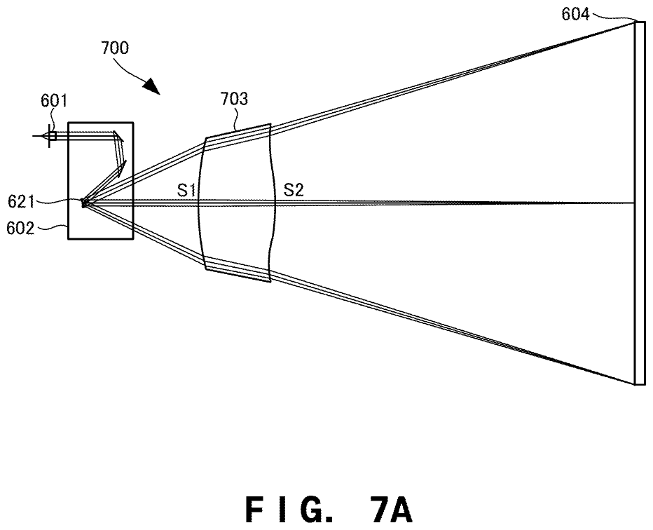

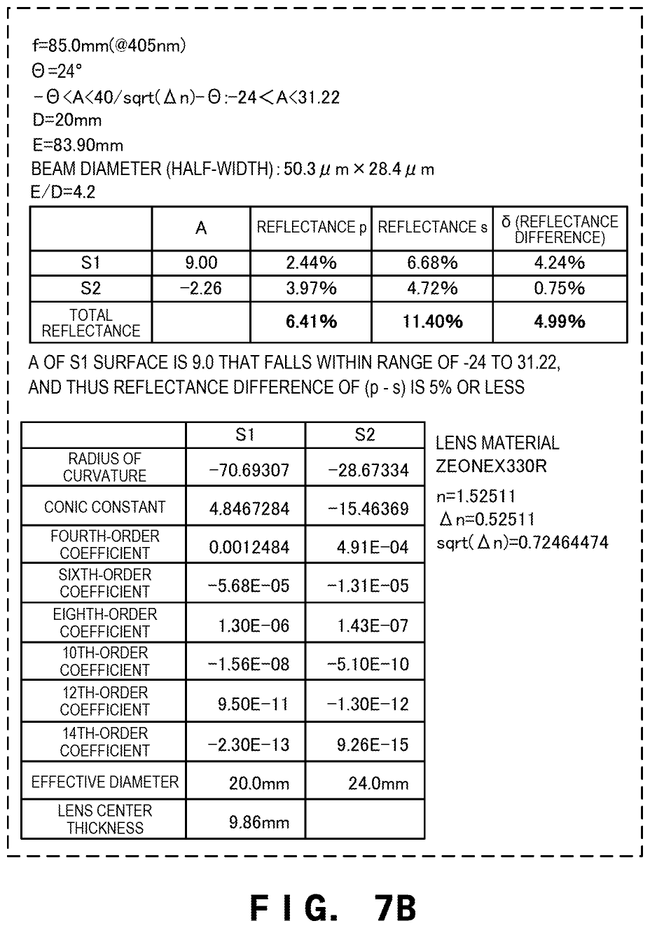

A three-dimensional shaping apparatus according to the fourth example embodiment of the present invention will be described next with reference to FIGS. 7A and 7B. FIG. 7A is a view showing an outline of the arrangement of the three-dimensional shaping apparatus according to this example embodiment. FIG. 7B is a view showing the performance of a condenser lens of the three-dimensional shaping apparatus according to this example embodiment. The three-dimensional shaping apparatus according to this example embodiment is different from those in the above-described second and third example embodiments in that the condenser lens has a different shape. The remaining components and operations are the same as those in the second and third example embodiments. Hence, the same reference numerals denote the same components and operations, and a detailed description thereof will be omitted.

A three-dimensional shaping apparatus 700 includes a laser source 601, an optical scanner 602, a condenser lens 703, and a shaping table 604. The lens material of the condenser lens 703 is ZEONEX330R, and the condenser lens 703 has a focal length (f) of 85.00 mm (405 nm laser beam) and a laser beam deflection angle (Θ) of 24°, satisfies −24<A<31.22, and has other characteristics shown in FIG. 7B.

The sum of the difference between the reflectance of vertically polarized light and that of horizontally polarized light on an S1 surface and the difference between the reflectance of the vertically polarized light and that of the horizontally polarized light on an S2 surface is 4.99% which is less than 5%. A distance D from the two-dimensional MEMS mirror 621 to the S1 surface is 20 mm, a distance E from the two-dimensional MEMS mirror 621 to the shaping table 604 is 83.90 mm, and E/D is 4.2. The beam diameter of a laser beam condensed by the condenser lens 703 and reduced is 50.3 μm×28.4 μm.

According to this example embodiment, it is possible to reduce the beam diameter of the laser beam, and thus perform uniform shaping. In addition, precise processing is possible.

### Fifth Example Embodiment

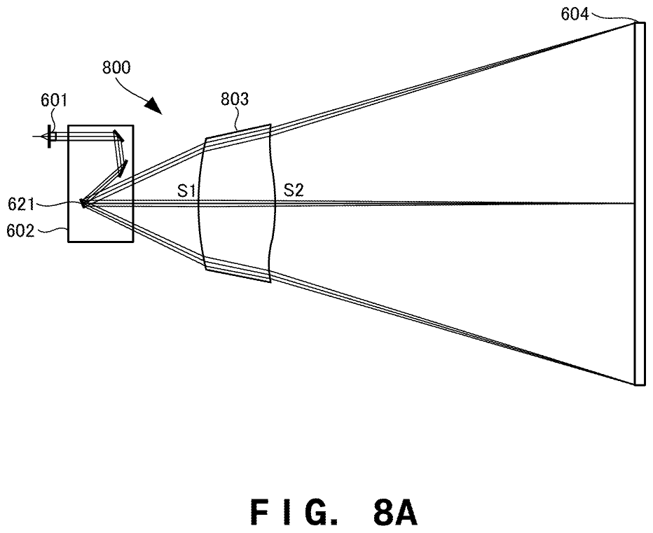

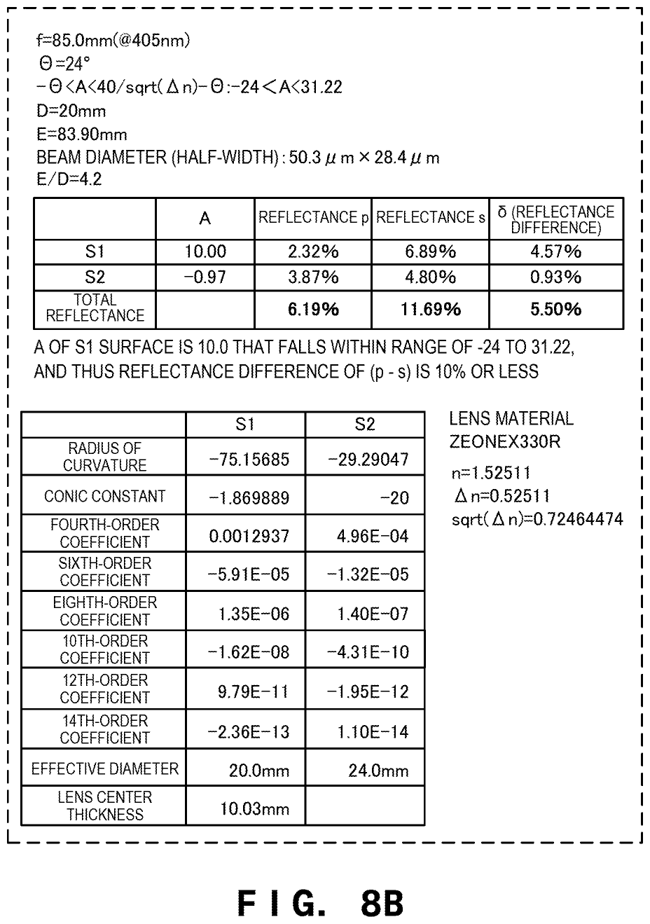

A three-dimensional shaping apparatus according to the fifth example embodiment of the present invention will be described next with reference to FIGS. 8A and 8B. FIG. 8A is a view showing an outline of the arrangement of the three-dimensional shaping apparatus according to this example embodiment. FIG. 8B is a view showing the performance of a condenser lens of the three-dimensional shaping apparatus according to this example embodiment. The three-dimensional shaping apparatus according to this example embodiment is different from those in the above-described second to fourth example embodiments in that the condenser lens has a different shape. The remaining components and operations are the same as those in the second to fourth example embodiments. Hence, the same reference numerals denote the same components and operations, and a detailed description thereof will be omitted.

A three-dimensional shaping apparatus 800 includes a laser source 601, an optical scanner 602, a condenser lens 803, and a shaping table 604. The lens material of the condenser lens 803 is ZEONEX330R, and the condenser lens 803 has a focal length (f) of 85.00 mm (405 nm laser beam) and a laser beam deflection angle (Θ) of 24°, satisfies −24<A<31.22, and has other characteristics shown in FIG. 8B.

The sum of the difference between the reflectance of vertically polarized light and that of horizontally polarized light on an S1 surface and the difference between the reflectance of the vertically polarized light and that of the horizontally polarized light on an S2 surface is 5.50% which is less than 10%. A distance D from the two-dimensional MEMS mirror 621 to the S1 surface is 20 mm, a distance E from the two-dimensional MEMS mirror 621 to the shaping table 604 is 83.90 mm, and E/D is 4.2. The beam diameter of a laser beam condensed by the condenser lens 803 and reduced is 50.3 μm×28.4 μm.

According to this example embodiment, it is possible to reduce the beam diameter of the laser beam, and thus perform uniform shaping. In addition, precise processing is possible.

### Sixth Example Embodiment

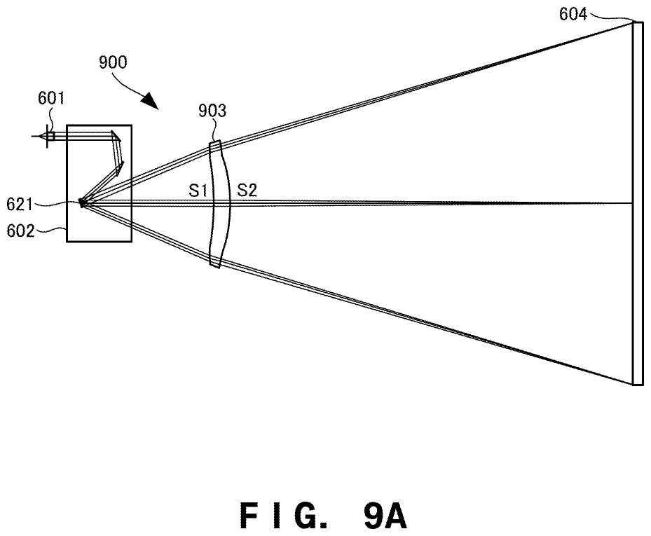

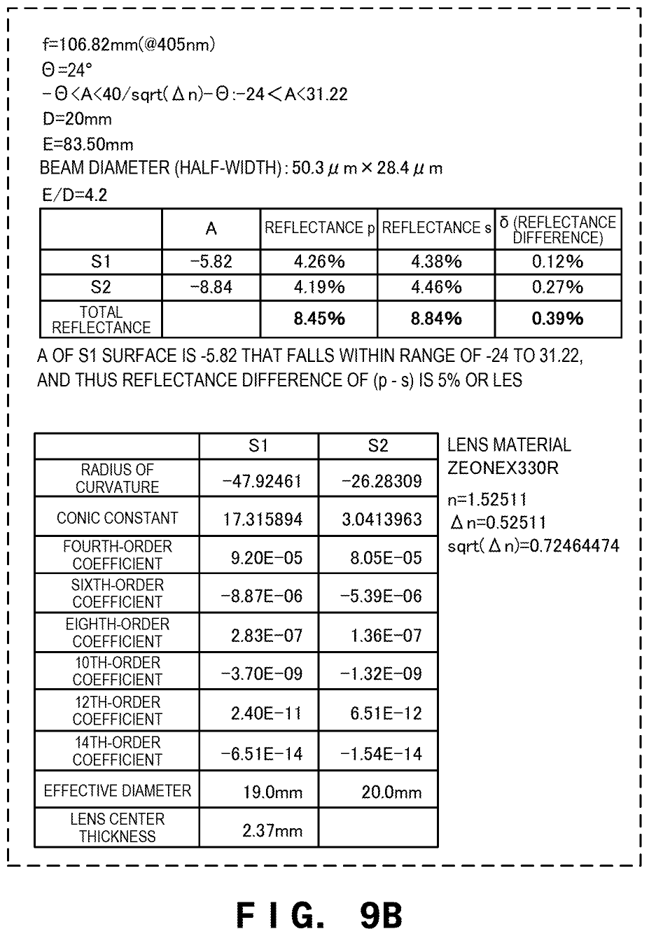

A three-dimensional shaping apparatus according to the sixth example embodiment of the present invention will be described next with reference to FIGS. 9A and 9B. FIG. 9A is a view showing an outline of the arrangement of the three-dimensional shaping apparatus according to this example embodiment. FIG. 9B is a view showing the performance of a condenser lens of the three-dimensional shaping apparatus according to this example embodiment. The three-dimensional shaping apparatus according to this example embodiment is different from those in the above-described second to fifth example embodiments in that the condenser lens has a different shape. The remaining components and operations are the same as those in the second to fifth example embodiments. Hence, the same reference numerals denote the same components and operations, and a detailed description thereof will be omitted.

A three-dimensional shaping apparatus 900 includes a laser source 601, an optical scanner 602, a condenser lens 903, and a shaping table 604. The lens material of the condenser lens 903 is ZEONEX330R, and the condenser lens 903 has a focal length (f) of 106.82 mm (405 nm laser beam) and a laser beam deflection angle (Θ) of 24°, satisfies −24<A<31.22, and has other characteristics shown in FIG. 9B.

The sum of the difference between the reflectance of vertically polarized light and that of horizontally polarized light on an S1 surface and the difference between the reflectance of the vertically polarized light and that of the horizontally polarized light on an S2 surface is 0.39% which is less than 5%. A distance D from the two-dimensional MEMS mirror 621 to the S1 surface is 20 mm, a distance E from the two-dimensional MEMS mirror 621 to the shaping table 604 is 83.50 mm, and E/D is 4.2. The beam diameter of a laser beam condensed by the condenser lens 903 and reduced is 50.3 μm×28.4 μm.

According to this example embodiment, it is possible to reduce the beam diameter of the laser beam, and thus perform uniform shaping. In addition, precise processing is possible.

### Seventh Example Embodiment

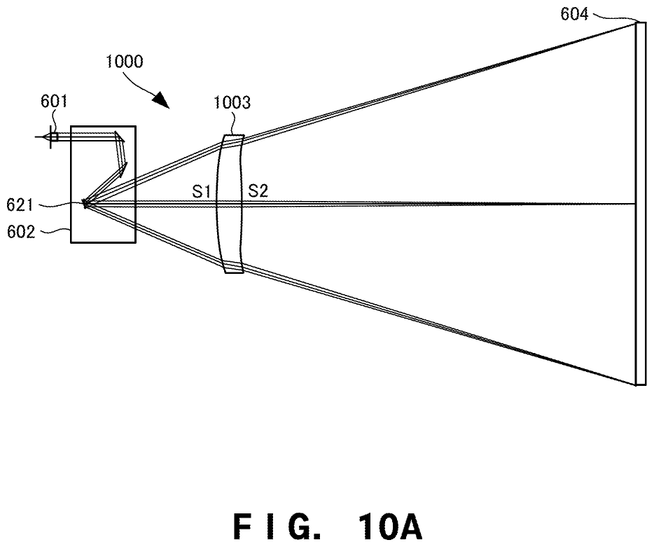

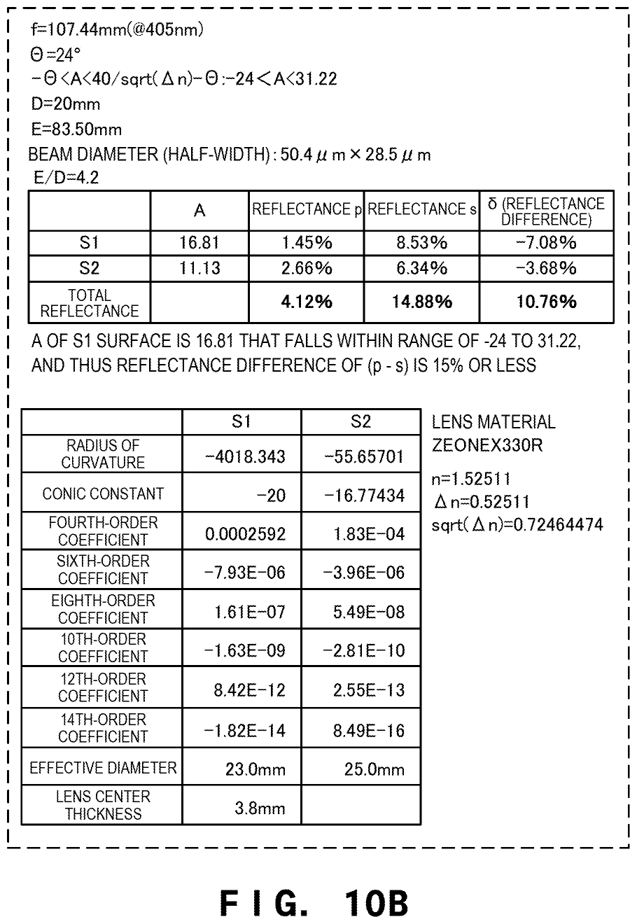

A three-dimensional shaping apparatus according to the seventh example embodiment of the present invention will be described next with reference to FIGS. 10A and 10B. FIG. 10A is a view showing an outline of the arrangement of the three-dimensional shaping apparatus according to this example embodiment. FIG. 10B is a view showing the performance of a condenser lens of the three-dimensional shaping apparatus according to this example embodiment. The three-dimensional shaping apparatus according to this example embodiment is different from those in the above-described second to sixth example embodiments in that the condenser lens has a different shape. The remaining components and operations are the same as those in the second to sixth example embodiments. Hence, the same reference numerals denote the same components and operations, and a detailed description thereof will be omitted.

A three-dimensional shaping apparatus 1000 includes a laser source 601, an optical scanner 602, a condenser lens 1003, and a shaping table 604. The lens material of the condenser lens 1003 is ZEONEX330R, and the condenser lens 1003 has a focal length (f) of 107.44 mm (405 nm laser beam) and a laser beam deflection angle (Θ) of 24°, satisfies −24<A<31.22, and has other characteristics shown in FIG. 10B.

The sum of the difference between the reflectance of vertically polarized light and that of horizontally polarized light on an S1 surface and the difference between the reflectance of the vertically polarized light and that of the horizontally polarized light on an S2 surface is 10.76% which is less than 15%. A distance D from the two-dimensional MEMS mirror 621 to the S1 surface is 20 mm, a distance E from the two-dimensional MEMS mirror 621 to the shaping table 604 is 83.50 mm, and E/D is 4.2. The beam diameter of a laser beam condensed by the condenser lens 1003 and reduced is 50.4 μm×28.5 μm.

According to this example embodiment, it is possible to reduce the beam diameter of the laser beam, and thus perform uniform shaping. In addition, precise processing is possible.

### Eighth Example Embodiment

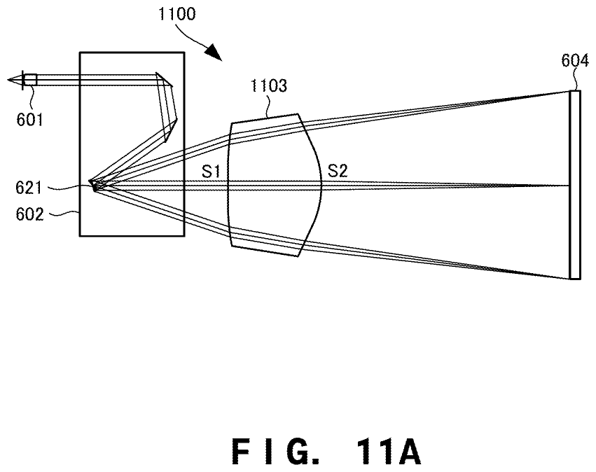

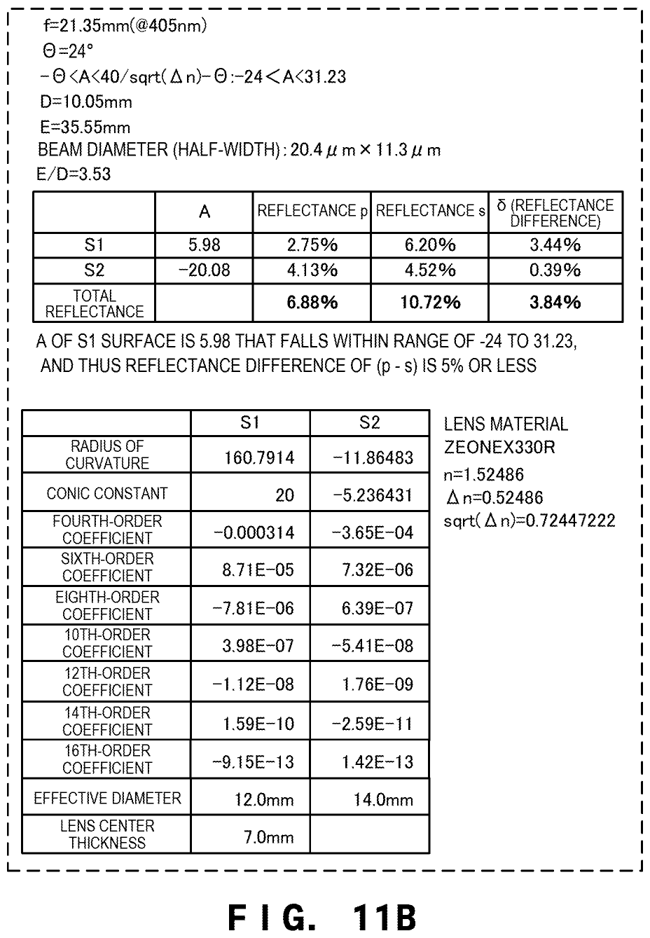

A three-dimensional shaping apparatus according to the eighth example embodiment of the present invention will be described next with reference to FIGS. 11A and 11B. FIG. 11A is a view showing an outline of the arrangement of the three-dimensional shaping apparatus according to this example embodiment. FIG. 11B is a view showing the performance of a condenser lens of the three-dimensional shaping apparatus according to this example embodiment. The three-dimensional shaping apparatus according to this example embodiment is different from those in the above-described second to seventh example embodiments in that the condenser lens has a different shape. The remaining components and operations are the same as those in the second to seventh example embodiments. Hence, the same reference numerals denote the same components and operations, and a detailed description thereof will be omitted.

A three-dimensional shaping apparatus 1100 includes a laser source 601, an optical scanner 602, a condenser lens 1103, and a shaping table 604. The lens material of the condenser lens 1103 is ZEONEX350R, and the condenser lens 1103 has a focal length (f) of 21.35 mm (405 nm laser beam) and a laser beam deflection angle (Θ) of 24°, satisfies −24<A<31.23, and has other characteristics shown in FIG. 11B.

The sum of the difference between the reflectance of vertically polarized light and that of horizontally polarized light on an S1 surface and the difference between the reflectance of the vertically polarized light and that of the horizontally polarized light on an S2 surface is 3.84% which is less than 5%. A distance D from the two-dimensional MEMS mirror 621 to the S1 surface is 10.05 mm, a distance E from the two-dimensional MEMS mirror 621 to the shaping table 604 is 35.55 mm, and E/D is 3.53. The beam diameter of a laser beam condensed by the condenser lens 1103 and reduced is 20.4 μm×11.3 μm.

According to this example embodiment, it is possible to reduce the beam diameter of the laser beam, and thus perform uniform shaping. In addition, precise processing is possible.

### Ninth Example Embodiment

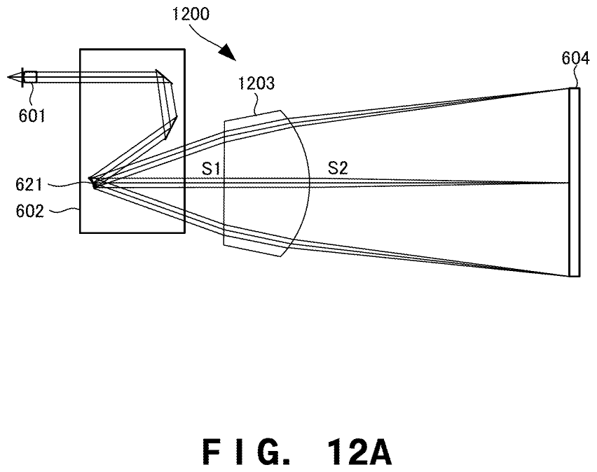

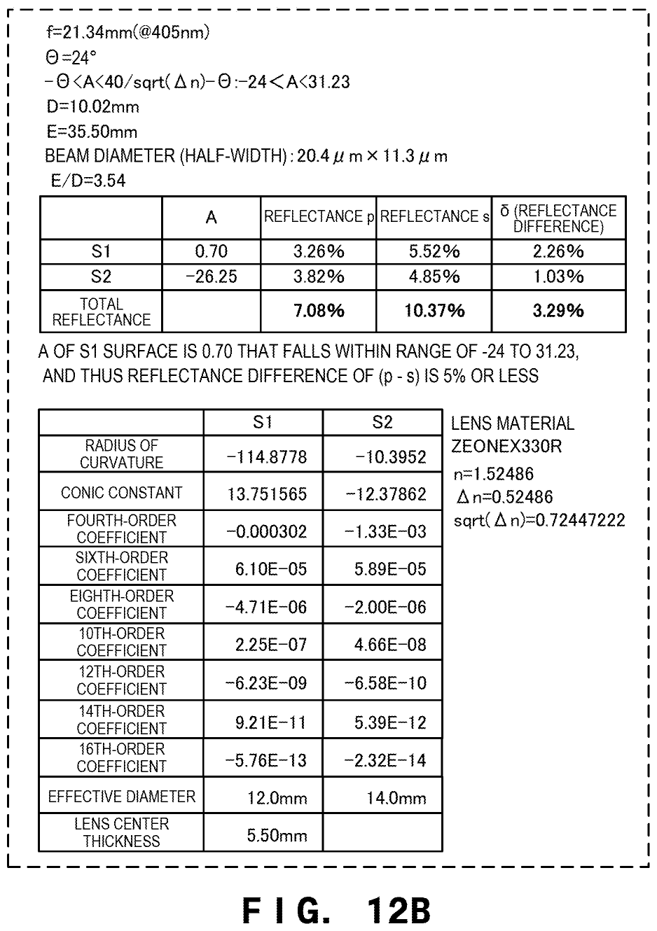

A three-dimensional shaping apparatus according to the ninth example embodiment of the present invention will be described next with reference to FIGS. 12A and 12B. FIG. 12A is a view showing an outline of the arrangement of the three-dimensional shaping apparatus according to this example embodiment. FIG. 12B is a view showing the performance of a condenser lens of the three-dimensional shaping apparatus according to this example embodiment. The three-dimensional shaping apparatus according to this example embodiment is different from those in the above-described second to eighth example embodiments in that the condenser lens has a different shape. The remaining components and operations are the same as those in the second to eighth example embodiments. Hence, the same reference numerals denote the same components and operations, and a detailed description thereof will be omitted.

A three-dimensional shaping apparatus 1200 includes a laser source 601, an optical scanner 602, a condenser lens 1203, and a shaping table 604. The lens material of the condenser lens 1203 is ZEONEX350R, and the condenser lens 1203 has a focal length (f) of 21.34 mm (405 nm laser beam) and a laser beam deflection angle (Θ) of 24°, satisfies −24<A<31.23, and has other characteristics shown in FIG. 12B.

The sum of the difference between the reflectance of vertically polarized light and that of horizontally polarized light on an S1 surface and the difference between the reflectance of the vertically polarized light and that of the horizontally polarized light on an S2 surface is 3.29% which is less than 5%. A distance D from the two-dimensional MEMS mirror 621 to the S1 surface is 10.02 mm, a distance E from the two-dimensional MEMS mirror 621 to the shaping table 604 is 35.50 mm, and E/D is 3.54. The beam diameter of a laser beam condensed by the condenser lens 1203 and reduced is 20.4 μm×11.3 μm.

According to this example embodiment, it is possible to reduce the beam diameter of the laser beam, and thus perform uniform shaping. In addition, precise processing is possible.

### 10th Example Embodiment

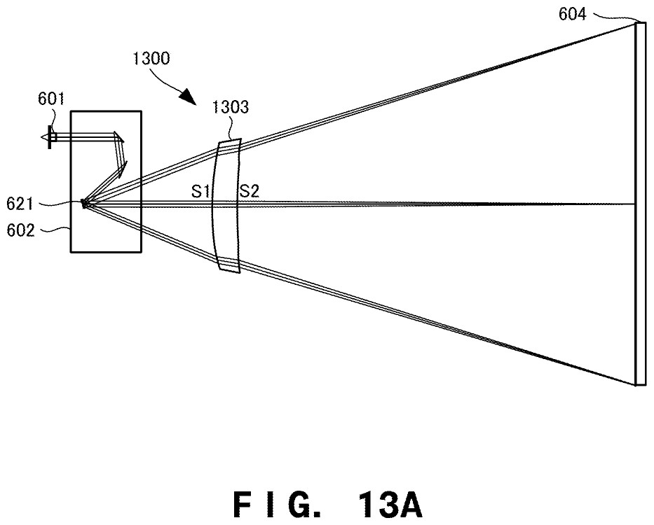

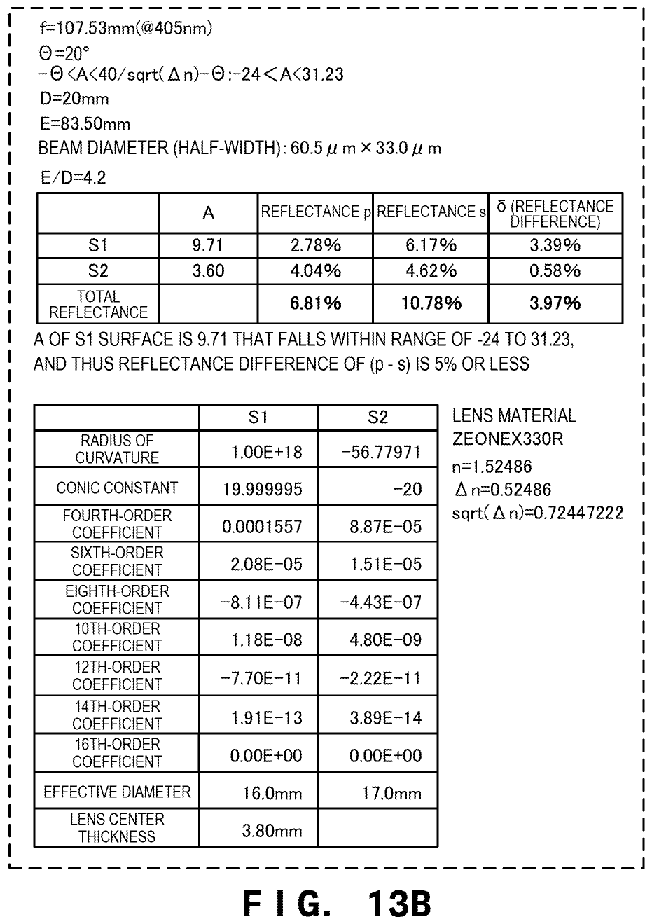

A three-dimensional shaping apparatus according to the 10th example embodiment of the present invention will be described next with reference to FIGS. 13A and 13B. FIG. 13A is a view showing an outline of the arrangement of the three-dimensional shaping apparatus according to this example embodiment. FIG. 13B is a view showing the performance of a condenser lens of the three-dimensional shaping apparatus according to this example embodiment. The three-dimensional shaping apparatus according to this example embodiment is different from those in the above-described second to ninth example embodiments in that the condenser lens has a different shape. The remaining components and operations are the same as those in the second to ninth example embodiments. Hence, the same reference numerals denote the same components and operations, and a detailed description thereof will be omitted.

A three-dimensional shaping apparatus 1300 includes a laser source 601, an optical scanner 602, a condenser lens 1303, and a shaping table 604. The lens material of the condenser lens 1303 is ZEONEX350R, and the condenser lens 1303 has a focal length (f) of 107.53 mm (405 nm laser beam) and a laser beam deflection angle (Θ) of 20°, satisfies −24<A<31.23, and has other characteristics shown in FIG. 13B.

The sum of the difference between the reflectance of vertically polarized light and that of horizontally polarized light on an S1 surface and the difference between the reflectance of the vertically polarized light and that of the horizontally polarized light on an S2 surface is 3.97% which is less than 5%. A distance D from the two-dimensional MEMS mirror 621 to the S1 surface is 20 mm, a distance E from the two-dimensional MEMS mirror 621 to the shaping table 604 is 83.50 mm, and E/D is 4.2. The beam diameter of a laser beam condensed by the condenser lens 1303 and reduced is 60.5 μm×33.0 μm.

According to this example embodiment, it is possible to reduce the beam diameter of the laser beam, and thus perform uniform shaping. In addition, precise processing is possible.

### 11th Example Embodiment

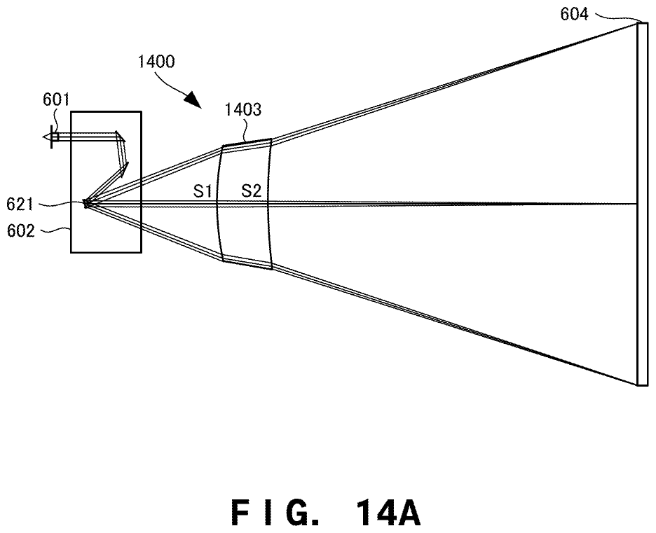

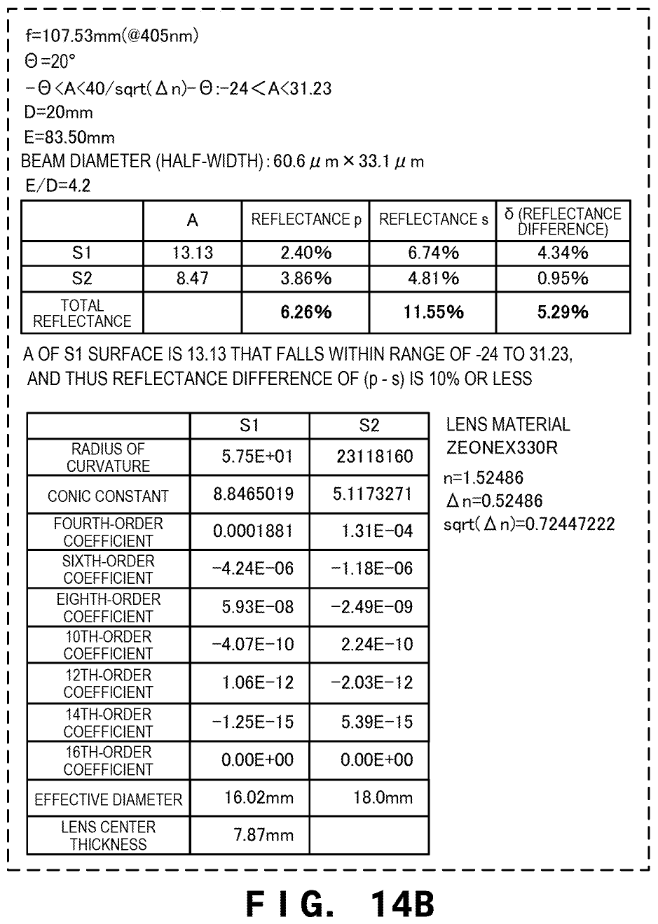

A three-dimensional shaping apparatus according to the 11th example embodiment of the present invention will be described next with reference to FIGS. 14A and 14B. FIG. 14A is a view showing an outline of the arrangement of the three-dimensional shaping apparatus according to this example embodiment. FIG. 14B is a view showing the performance of a condenser lens of the three-dimensional shaping apparatus according to this example embodiment. The three-dimensional shaping apparatus according to this example embodiment is different from those in the above-described second to 10th example embodiments in that the condenser lens has a different shape. The remaining components and operations are the same as those in the second to 10th example embodiments. Hence, the same reference numerals denote the same components and operations, and a detailed description thereof will be omitted.

A three-dimensional shaping apparatus 1400 includes a laser source 601, an optical scanner 602, a condenser lens 1403, and a shaping table 604. The lens material of the condenser lens 1403 is ZEONEX350R, and the condenser lens 1403 has a focal length (f) of 107.53 mm (405 nm laser beam) and a laser beam deflection angle (Θ) of 20°, satisfies −24<A<31.23, and has other characteristics shown in FIG. 14B.

The sum of the difference between the reflectance of vertically polarized light and that of horizontally polarized light on an S1 surface and the difference between the reflectance of the vertically polarized light and that of the horizontally polarized light on an S2 surface is 5.29% which is less than 10%. A distance D from the two-dimensional MEMS mirror 621 to the S1 surface is 20 mm, a distance E from the two-dimensional MEMS mirror 621 to the shaping table 604 is 83.50 mm, and E/D is 4.2. The beam diameter of a laser beam condensed by the condenser lens 1403 and reduced is 60.6 μm×33.1 μm.

According to this example embodiment, it is possible to reduce the beam diameter of the laser beam, and thus perform uniform shaping. In addition, precise processing is possible.

### 12th Example Embodiment

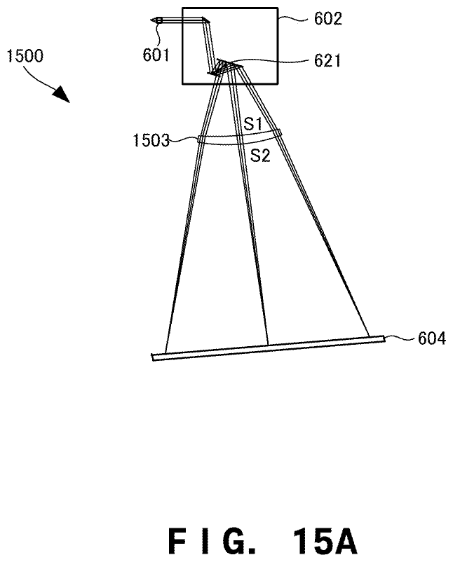

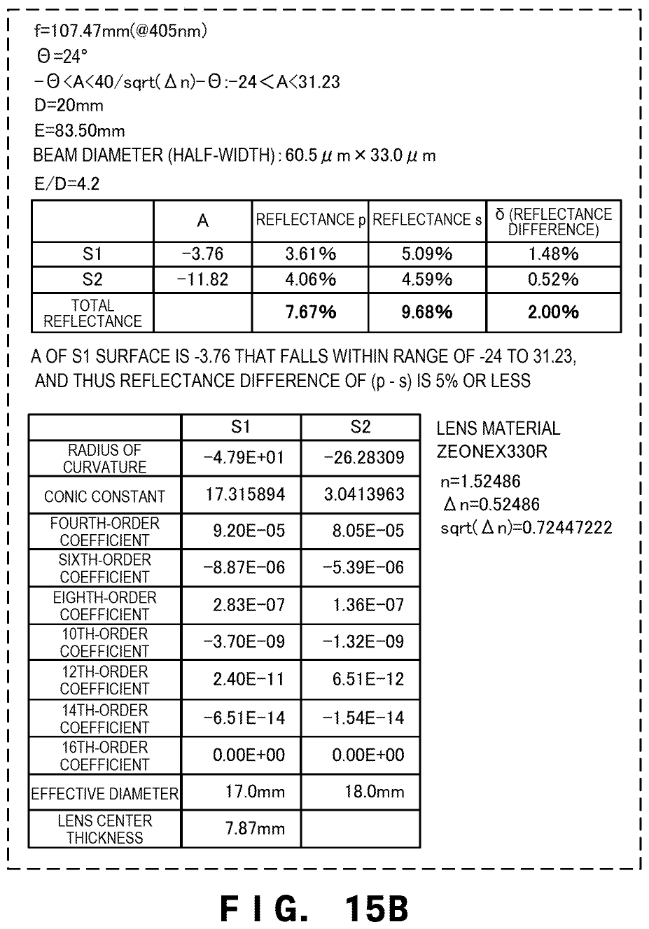

A three-dimensional shaping apparatus according to the 12th example embodiment of the present invention will be described next with reference to FIGS. 15A and 15B. FIG. 15A is a view showing an outline of the arrangement of the three-dimensional shaping apparatus according to this example embodiment. FIG. 15B is a view showing the performance of a condenser lens of the three-dimensional shaping apparatus according to this example embodiment. The three-dimensional shaping apparatus according to this example embodiment is different from those in the above-described second to 11th example embodiments in that the condenser lens has a different shape. The remaining components and operations are the same as those in the second to 11th example embodiments. Hence, the same reference numerals denote the same components and operations, and a detailed description thereof will be omitted.

A three-dimensional shaping apparatus 1500 includes a laser source 601, an optical scanner 602, a condenser lens 1503, and a shaping table 604. The lens material of the condenser lens 1503 is ZEONEX350R, and the condenser lens 1503 has a focal length (f) of 107.47 mm (405 nm laser beam) and a laser beam deflection angle (Θ) of 24°, satisfies −24<A<31.23, and has other characteristics shown in FIG. 15B.

The sum of the difference between the reflectance of vertically polarized light and that of horizontally polarized light on an S1 surface and the difference between the reflectance of the vertically polarized light and that of the horizontally polarized light on an S2 surface is 2.00% which is less than 5%. A distance D from the two-dimensional MEMS mirror 621 to the S1 surface is 20 mm, a distance E from the two-dimensional MEMS mirror 621 to the shaping table 604 is 83.50 mm, and E/D is 4.2. The beam diameter of a laser beam condensed by the condenser lens 1503 and reduced is 60.5 μm×33.0 μm.

According to this example embodiment, it is possible to reduce the beam diameter of the laser beam, and thus perform uniform shaping. In addition, precise processing is possible.

### 13th Example Embodiment

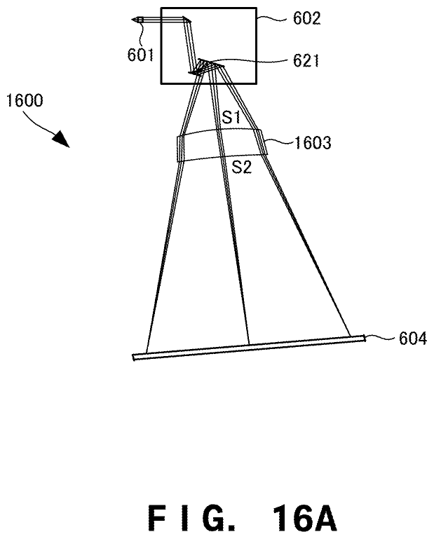

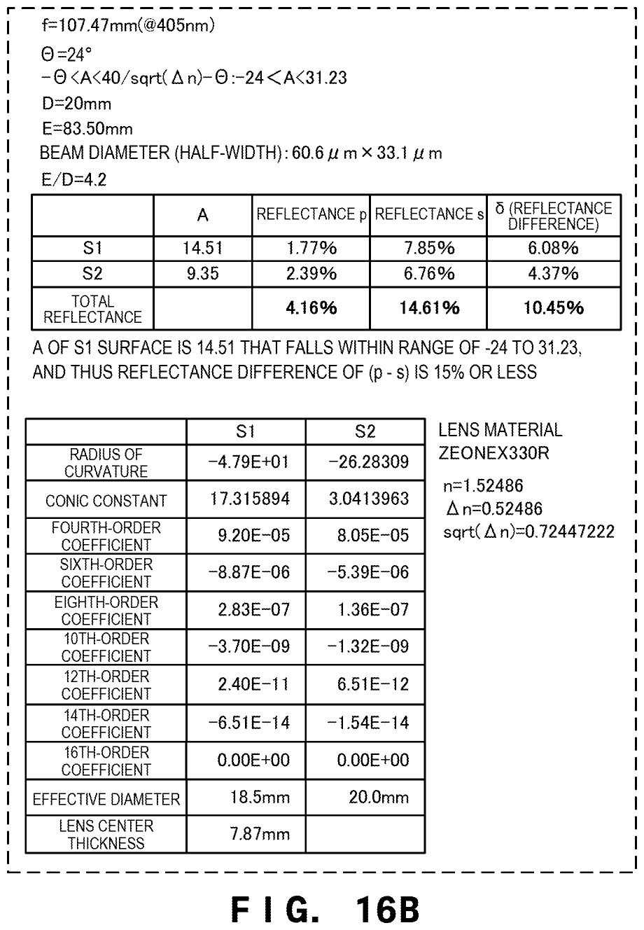

A three-dimensional shaping apparatus according to the 13th example embodiment of the present invention will be described next with reference to FIGS. 16A and 16B. FIG. 16A is a view showing an outline of the arrangement of the three-dimensional shaping apparatus according to this example embodiment. FIG. 16B is a view showing the performance of a condenser lens of the three-dimensional shaping apparatus according to this example embodiment. The three-dimensional shaping apparatus according to this example embodiment is different from those in the above-described second to 12th example embodiments in that the condenser lens has a different shape. The remaining components and operations are the same as those in the second to 12th example embodiments. Hence, the same reference numerals denote the same components and operations, and a detailed description thereof will be omitted.

A three-dimensional shaping apparatus 1600 includes a laser source 601, an optical scanner 602, a condenser lens 1603, and a shaping table 604. The lens material of the condenser lens 1603 is ZEONEX350R, and the condenser lens 1603 has a focal length (f) of 107.47 mm (405 nm laser beam) and a laser beam deflection angle (Θ) of 24°, satisfies −24<A<31.23, and has other characteristics shown in FIG. 16B.

The sum of the difference between the reflectance of vertically polarized light and that of horizontally polarized light on an S1 surface and the difference between the reflectance of the vertically polarized light and that of the horizontally polarized light on an S2 surface is 10.45% which is less than 15%. A distance D from the two-dimensional MEMS mirror 621 to the S1 surface is 20 mm, a distance E from the two-dimensional MEMS mirror 621 to the shaping table 604 is 83.50 mm, and E/D is 4.2. The beam diameter of a laser beam condensed by the condenser lens 1603 and reduced is 60.6 μm×33.1 pm.

According to this example embodiment, it is possible to reduce the beam diameter of the laser beam, and thus perform uniform shaping. In addition, precise processing is possible.

### 14th Example Embodiment

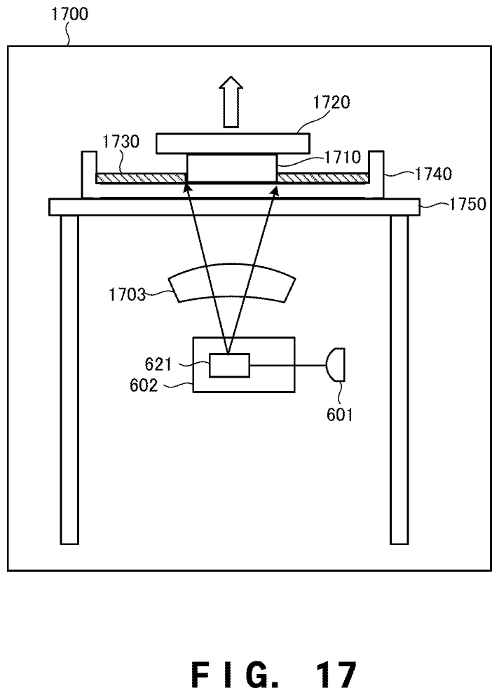

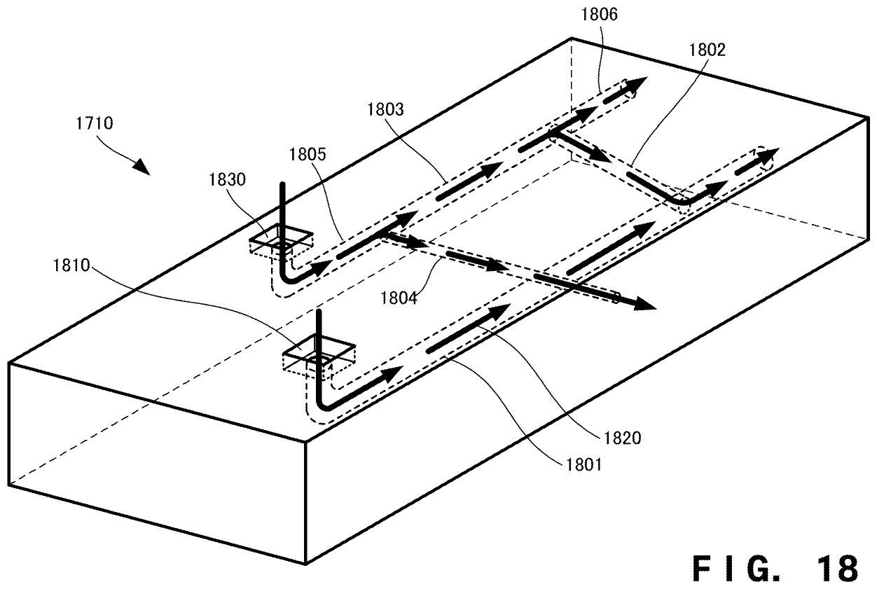

A three-dimensional shaping apparatus according to the 14th example embodiment of the present invention will be described next with reference to FIGS. 17 and 18. FIG. 17 is a view for explaining the arrangement of the three-dimensional shaping apparatus according to this example embodiment. The three-dimensional shaping apparatus according to this example embodiment includes, as a condenser lens, one of the condenser lenses described in the above second to 13th example embodiments.

A three-dimensional shaping apparatus 1700 includes a laser source 601, an optical scanner 602, and a condenser lens 1703. The condenser lens 1703 is one of the condenser lenses described in the above second to 13th example embodiments. A two-dimensional MEMS mirror 621 reflects a laser beam to be scanned toward a resin 1730 in a vat 1740 placed on a stage 1750. The resin 1730 is a resin used as the material of a three-dimensional shaped object 1710. Then, the three-dimensional shaping apparatus 1700 irradiates the resin 1730 in the vat 1740 with the laser beam condensed by the condenser lens 1703 while raising a platform 1720. The resin 1730 is a photo-curing resin that is cured when it is irradiated with the laser beam.

FIG. 18 is a perspective view showing an example of the three-dimensional shaped object including microchannels shaped using the three-dimensional shaping apparatus according to this example embodiment. The three-dimensional shaped object 1710 includes microchannels 1801, 1802, 1803, 1804, 1805, and 1806 which are provided in the three-dimensional shaped object 1710 as a rectangular parallelepiped having a length of 2.5 cm, a width of 1 cm, and a height of 4 mm. A liquid infused from a liquid reservoir 1810 flows through the microchannel 1801 along arrows 1820. The liquid flowing through the microchannel 1801 meets with a liquid flowing from the microchannel 1802, and is then discharged outside. A liquid infused from a liquid reservoir 1830 flows through the microchannel 1805, and branches to the microchannels 1803 and 1804 in accordance with the size of a particle in the liquid. The liquid flowing through the microchannel 1803 branches to the microchannels 1802 and 1806 in accordance with a specific gravity.

The microchannels 1801 and 1803 are connected by the microchannel 1802 as a channel inclined in a cross section. The microchannels 1801, 1803, and 1804 are connected to the outside. Note that the channel diameters of the microchannels 1801, 1802, 1803, 1804, 1805, and 1806 are set to arbitrary sizes to separate the liquid.

The liquid made to flow through the microchannels 1801, 1802, 1803, 1804, 1805, and 1806 is blood or the like. By making blood flow through the microchannels 1801, 1802, 1803, 1804, 1805, and 1806, it is possible to separate red blood cells, white blood cells, platelets, and the like as blood components. The separated components are discharged outside from the microchannels 1801, 1804, and 1806.

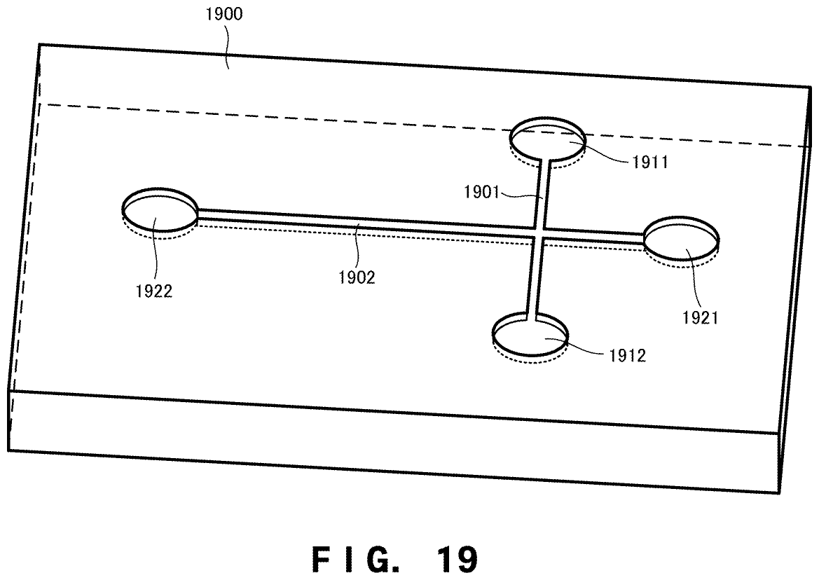

FIG. 19 is a perspective view showing another example of the three-dimensional shaped object including microchannels shaped using the three-dimensional shaping apparatus according to this example embodiment. A three-dimensional shaped object 1900 includes four liquid reservoirs 1911, 1912, 1921, and 1922 and microchannels 1901 and 1902. The microchannels 1901 and 1902 of a standard cross pattern are shaped. The liquid reservoirs 1911 and 1912 are provided at two ends of the microchannel 1901. That is, the liquid reservoirs 1911 and 1912 are connected by the microchannel 1901. The liquid reservoirs 1921 and 1922 are provided at two ends of the microchannel 1902. The liquid reservoirs 1921 and 1922 are connected by the microchannel 1902. The microchannels 1901 and 1902 are orthogonal to each other. The microchannels 1901 and 1902 are connected at an orthogonal portion.

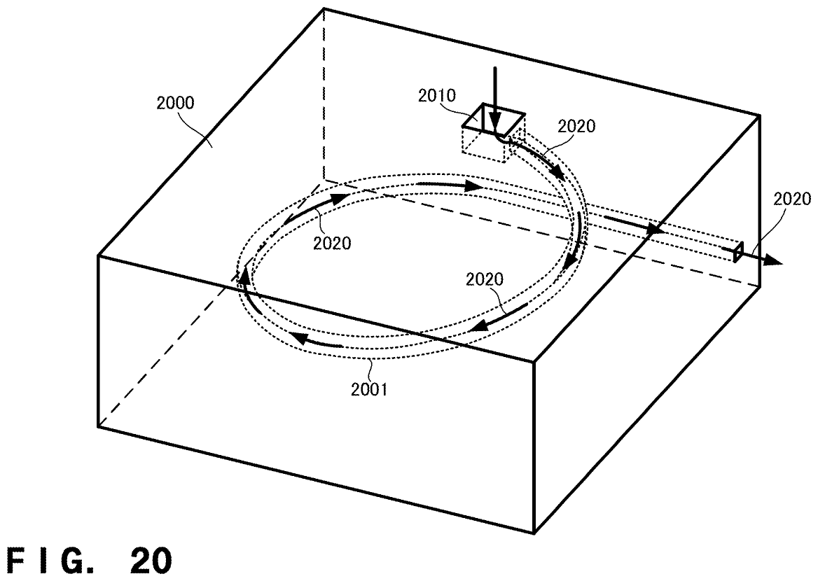

FIG. 20 is a perspective view showing still other example of the three-dimensional shaped object including microchannels shaped using the three-dimensional shaping apparatus according to this example embodiment. A three-dimensional shaped object 2000 includes a microchannel 2001 having a spiral shape (single spiral). A liquid infused from a liquid reservoir 2010 flows through the microchannel 2001 having the spiral shape along arrows 2020, and is discharged outside.

According to this example embodiment, it is possible to reduce the beam diameter of the laser beam, and thus shape a uniform and precise three-dimensional shaped object. Since it is possible to shape a precise three-dimensional shaped object, fine shaping of a microchannel or the like can be performed.

### Other Example Embodiments

While the invention has been particularly shown and described with reference to example embodiments thereof, the invention is not limited to these example embodiments. It will be understood by those of ordinary skill in the art that various changes in form and details may be made therein without departing from the spirit and scope of the present invention as defined by the claims.

1. A three-dimensional shaping apparatus comprising:
a laser source;
an optical scanner that reflects a laser beam emitted from said laser source to be scanned toward a shaping table; and
a condenser lens that is arranged between said optical scanner and the shaping table, and condenses the laser beam reflected by said optical scanner.

2. The apparatus according to claim 1, wherein when D represents a distance from said optical scanner to said condenser lens and E represents a distance from said optical scanner to the shaping table, said condenser lens is arranged at a position where E/D<5.0 is satisfied.

3. The apparatus according to claim 2, wherein said condenser lens is arranged at a position where 3.5<E/D is satisfied.

4. The apparatus according to claim 1, wherein when A represents a normal angle, Θ represents a laser beam deflection angle, and Δn represents a refractive index difference between said condenser lens and air, said condenser lens satisfies −Θ<A<40/sqrt(Δn)−0.

5. The apparatus according to claim 1, wherein said condenser lens has a sum of a difference between a reflectance of vertically polarized light and a reflectance of horizontally polarized light on a surface close to said optical scanner out of two surfaces of said condenser lens and a difference between a reflectance of the vertically polarized light and a reflectance of the horizontally polarized light on a surface far from said optical scanner out of the two surfaces of said condenser lens, which is not more than 15%.

6. The apparatus according to claim 5, wherein said condenser lens has the sum of the difference between the reflectance of the vertically polarized light and the reflectance of the horizontally polarized light on the surface close to said optical scanner out of the two surfaces of said condenser lens and the difference between the reflectance of the vertically polarized light and the reflectance of the horizontally polarized light on the surface far from said optical scanner out of the two surfaces of said condenser lens, which is not more than 10%.

7. The apparatus according to claim 6, wherein said condenser lens has the sum of the difference between the reflectance of the vertically polarized light and the reflectance of the horizontally polarized light on the surface close to said optical scanner out of the two surfaces of said condenser lens and the difference between the reflectance of the vertically polarized light and the reflectance of the horizontally polarized light on the surface far from said optical scanner out of the two surfaces of said condenser lens, which is not more than 5%.
